(19) United States
(12) Patent Application Publication
(10) Pub. No.: US 2006/0036961 A1
(43) Pub. Date: Feb. 16, 2006

(54) Method of extending virtual wallpaper for a portable electrical device

(75) Inventors: Shih-Chieh Chen, Taipei City (TW); Chien-Chung Chen, Taipei City (TW); Chieh-Yu Chan, Taipei City (TW); Chih-Ping Chang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/200,136

(22) Filed: Aug. 10, 2005

(30) Foreign Application Priority Data
Aug. 16, 2004 (TW) 093124538

(51) Int. Cl. G06F 3/00

(52) U.S. Cl. 715/765; 715/867; 715/744

(57) ABSTRACT

The present invention relates to one method of extending the wallpaper to be used in a portable electronic device, such as an MP3 player. The method comprises: (A) detecting a non-predetermined image; (B) determining whether or not to set the non-predetermined image as the wallpaper; if not, then the operation to extend the wallpaper will be ended; and (C) recording the non-predetermined image. The non-predetermined image is not provided by the MP3 player, and is recorded in a wallpaper database.

### BACKGROUND OF THE INVENTION

1. Field of the Invention

The present invention relates to one method of extending the wallpaper and, more particularly to be used in a portable electronic device.

2. Description of Related Art

As the electronic technology progresses, various kinds of electronic devices are increasingly being miniaturized. Examples are a PDA, a music player, etc. Those kinds of portable electronic devices, due to their portability and the special functional services they provide, or the powerful algorithm-processing ability they serve, provide the users great entertainment and convenience, achieving the purpose to be able to enjoy (seeing and hearing) entertainment or data-processing anytime.

As shown in FIG. 1, using an MP3 (a recording format of music) player 10 as an example, the display screen 12 of the MP3 player 10 may be divided into several display areas, including: a main display area 14, a functional area 16, and an indicator area 18. The main display area 14 serves to display electronic files, electronic catalogues, and written explanations. The functional area 16 serves to point out the functional options the current MP3 player 10 provide to the users. The indicator area 18 serves to indicate to the users the current function they have chosen. Moreover, the display screen 12 may display a virtual wallpaper i.e., a background image for an electronic device screen and one that provides special interest or attraction to the user [for the sake of brevity, hereinafter referred to as wallpaper]. The scope of the wallpaper may be restricted to the main display area 14, or to include the full display screen 12. In addition, the surface of the MP3 player 10 is installed with multiple function keys 20 that may select and execute specific functions.

The image of the wallpaper may be selected from multiple predetermined wallpapers. Also, the users may select non-predetermined images (such as the photos of the users) to be the wallpaper. However, generally the MP3 player 10 only provides one record for non-predetermined image. When the users wish to switch wallpaper between multiple non-predetermined images, they will experience difficulty.

### SUMMARY OF THE INVENTION

To avoid the above disadvantage, the present invention discloses one method of extending the wallpaper to be used in a portable electronic device, comprising: (A) detecting non-predetermined images; (B) determining whether or not to set the non-predetermined images as the wallpaper; if not, then the operation to extend the wallpaper will be ended; and (C) recording the non-predetermined images. The portable electronic device is an MP3 player and the non-predetermined images are recorded in a wallpaper database.

### BRIEF DESCRIPTION OF THE DRAWINGS

FIG. 1 is a front view of an MP3 player.

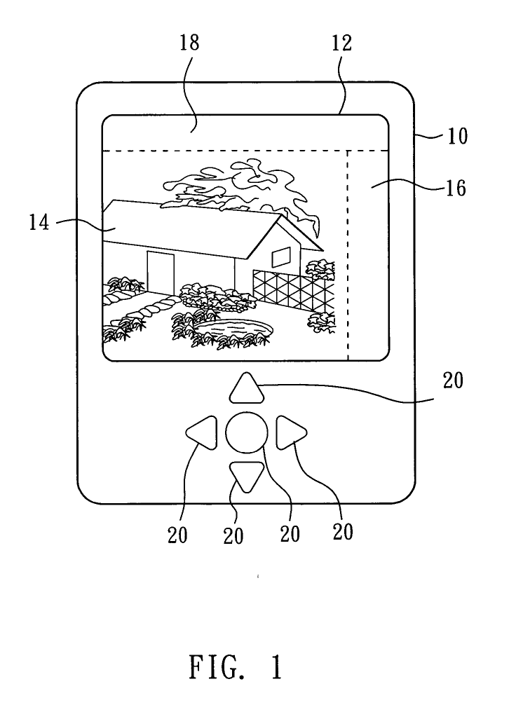

FIG. 2 is the flow chart of the method of extending electronic image wallpaper in accordance with the present invention.

FIG. 3 is the flow chart of the method of selecting electronic image wallpaper in prior art.

### DETAILED DESCRIPTION OF THE PREFERRED EMBODIMENT

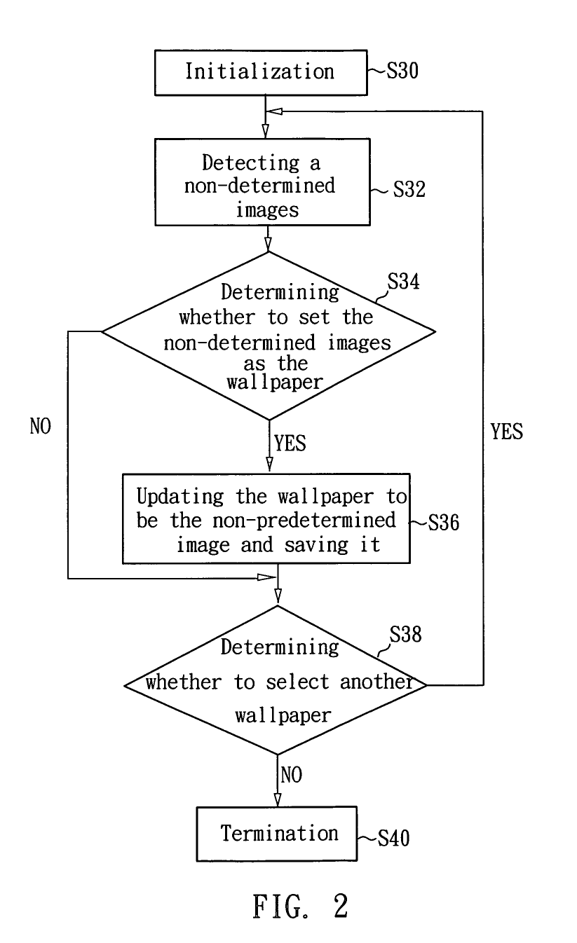

The method of extending an electronic image wallpaper of the present invention may be applied to a portable electronic device. Multiple non-predetermined images are selectively recordable, so the users can be provided more options for wallpaper. As shown in FIG. 2, the present invention for renovating the wallpaper, comprises the steps of:

Step S30: Initialization.

Step S32: Detecting a non-predetermined image. The non-predetermined image may be the users' photos, preferred images, art pictures, etc.

Step S34: Determining whether or not to set the non-determined image as the wallpaper. If not, then Step S38 is executed. When the users browse the non-predetermined image, they may press the function keys 20 of the MP3 player 10 to make the non-predetermined image able to be set as wallpaper.

Step S36: Updating the wallpaper to be the non-predetermined image and saving it. The MP3 player 10 may copy the non-predetermined image to a wallpaper database, and all stored/saved images in the wallpaper database can be used as wallpaper. Alternatively, the MP3 player 10 may establish a shortcut of the non-predetermined image to the wallpaper database. When the users select the non-predetermined image from the wallpaper database, the non-predetermined image may be loaded via a shortcut and set as the preferred wallpaper. Moreover, the MP3 player 10 can just record the non-predetermined image without updating the image to be wallpaper.

Step S38: Determining whether or not to extend another wallpaper; if yes, Step S32 is executed. When the users wish to extend multiple non-predetermined images as the options for wallpaper, they may add non-predetermined images to be the wallpaper one by one by repeating executing Step 32 to Step 38.

Step S40: Termination.

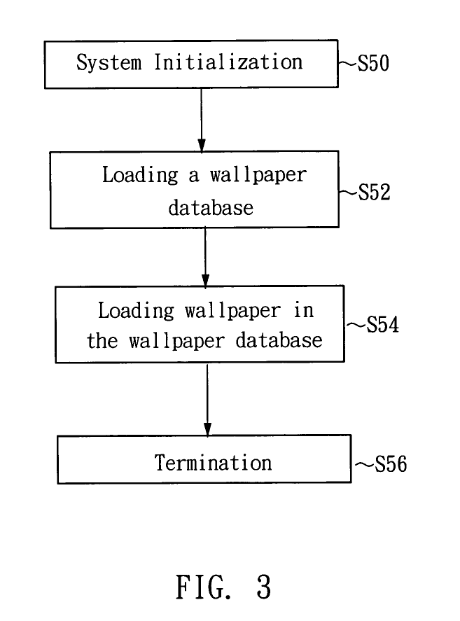

The wallpaper database stores both predetermined and non-predetermined images. Later on when the users wish to change the wallpaper, due to the wallpaper catalogue not only saving predetermined wallpaper, but also non-predetermined images, it provides the users more options for wallpaper and avoids causing users any trouble in wallpaper selection. The method for wallpaper selection depends on the functions provided by the MP3 player 10. Here stated is one of the prior methods for wallpaper selection, as shown in FIG. 3, comprising the steps of:

Step S50: System Initialization.

Step S52: Loading a wallpaper database. The wallpaper database stores non-predetermined and predetermined images that can be used as the wallpaper.

Step S54: Loading wallpaper in the wallpaper database and displaying it on the MP3 player 10. The users may select any one image stored in the wallpaper database as the wallpaper. When the users select the image, the MP3 player 10 will load the selected image to be wallpaper.

Step S56: Termination.

Due to the fact that a small-scale portable electronic device records predetermined wallpaper and non-predetermined images at the same time, both may be used as the wallpaper. Moreover, the options for non-predetermined images are not restricted to one, thus the users will be satisfied in the wallpaper selection.

Although the present invention has been explained in relation to its preferred embodiment, it is to be understood that many other possible modifications and variations can be made without departing from the spirit and scope of the invention as hereinafter claimed.

What is claimed is:

1. A method of extending electronic display wallpaper to be used in a portable electronic device, comprising the steps of:
(A) detecting a non-predetermined image;
(B) determining whether or not to set the non-determined image as the wallpaper; if not, stopping the operation of the method for extending wallpaper; and
(C) saving the non-determined image.

2. The method of claim 1, wherein the portable electronic device is an MP3 player.

3. The method of claim 2, wherein the non-predetermined image is recorded to a wallpaper database.

4. The method of claim 3, wherein the shortcut of the non-predetermined image is saved to the wallpaper database.

5. The method of claim 1, wherein the wallpaper may, via one method of updating wallpaper, be loaded and displayed on the portable electronic device, comprising the steps of:
(A) loading a wallpaper database; and
(B) loading the wallpaper into the wallpaper database and displaying a specific wallpaper from the database on the portable electronic device.

6. The method of claim 5, wherein the portable electronic device is an MP3 player.
